(19) United States
(12) Patent Application Publication
(10) Pub. No.: US 2014/0118606 A1
(43) Pub. Date: May 1, 2014

(54) SMART CAMERAS

(71) Applicant: Bhanu Sharma, Burlingame, CA (US)

(72) Inventor: Bhanu Sharma, Burlingame, CA (US)

(73) Assignee: SONY MOBILE COMMUNICATIONS AB, Lund (SE)

(21) Appl. No.: 13/983,688

(22) PCT Filed: Mar. 19, 2013
(86) PCT No.: PCT/US2013/032909

§ 371 Date: Aug. 5, 2013

Related U.S. Application Data
(60) Provisional application No. 61/612,422, filed on Mar. 19, 2012.

(51) Int. Cl. H04N 5/225; H04M 1/02

(52) U.S. Cl. CPC H04N 5/2254; H04M 1/0264
USPC 348/345

(57) ABSTRACT

A system includes a smart phone and an image receiving module. The smart phone includes a communication port and a camera. The image receiving module is capable of being physically coupled to the smart phone via the communication port. The image receiving module includes an iris for adjusting an aperture for rays entering the device via the aperture, based on user input, a set of lenses capable of zooming an image formed by the rays greater than a predetermined number of times an original size of the image, and a shutter whose speed is configurable based on user input.

### BACKGROUND

Many different types of devices are available today for taking pictures, improving captured images, and publishing the images. For example, a user can use a smart phone to take a picture and modify the picture using an image-editing application. The user can also publish the picture using a browser. In capturing the image, the user can also use a “point and shoot” camera or a digital single-lens reflect (SLR) camera.

### SUMMARY

According to one aspect a device may include: an iris for adjusting an aperture for rays entering the device via the aperture, based on user input; a set of lenses capable of zooming an image formed by the rays, greater than a predetermined number of times an original size of the image; a shutter whose speed is configurable based on user input; and a computing device. The computing device may include: a processor for controlling the device; a memory for storing applications, data, and the image obtained via the iris, the set of lenses, and the shutter; a display for displaying the image; and a communication interface for communicating with another device over a network.

Additionally, the predetermined number is 4.

Additionally, the computing device may include a cellular telephone.

Additionally, the processor may be configured to at least one of: modify the speed of the shutter based on a zoom of the set of lenses; change a size of the aperture by controlling the iris based on a zoom of the set of lenses; or perform a zoom via the set of lenses based on user input.

Additionally, the device may further include a sensor, wherein the processor is further configured to: automatically focus the image by controlling the set of lenses prior to capturing the image.

According to another aspect, a system may include a smart phone that includes a communication port and a camera, and an image receiving module configured to physically couple to the smart phone via the communication port. The image receiving module may include: an iris for adjusting an aperture for rays entering the device via the aperture, based on user input; a set of lenses capable of zooming an image formed by the rays greater than a predetermined number of times an original size of the image; and a shutter whose speed is configurable based on user input.

Additionally, the communication port is a universal serial bus (USB) port.

Additionally, the camera may be located on a side, of the smart phone, that includes a display, or on another side, of the smart phone, that does not include the display.

Additionally, the predetermined number is 3.

Additionally, the smart phone may be configured to send signals to control the set of lenses to autofocus the image.

### BRIEF DESCRIPTION OF THE DRAWINGS

The accompanying drawings, which are incorporated in and constitute a part of this specification, illustrate one or more embodiments described herein and, together with the description, explain the embodiments. In the drawings,

FIG. 1 shows an environment in which concepts described herein may be implemented;

FIGS. 2A and 2B are front and rear views, respectively, of the camera of FIG. 1 according to one implementation;

FIG. 3 is a block diagram of exemplary components of the camera of FIG. 1;

FIG. 4 is a block diagram of exemplary components of the image receive module of FIG. 3;

FIG. 5 is a block diagram of exemplary components of the computing device of FIG. 3;

FIG. 6 is a block diagram of exemplary functional components of the computing device of FIG. 3; and

FIGS. 7A and 7B illustrate the camera of FIG. 1 according to another implementation.

### DETAILED DESCRIPTION OF EMBODIMENTS

The following detailed description refers to the accompanying drawings. The same reference numbers in different drawings may identify the same or similar elements.

The term “image,” as used herein, may refer to a digital or an analog representation of visual information (e.g., a picture, a video, a photograph, an animation, etc). The term “camera,” as used herein, may include a device that may capture and store images. For example, a digital camera may include an electronic device that may capture and store images electronically instead of using photographic film. A digital camera may be multifunctional, with some devices capable of recording sound and/or images. A “subject,” as the term is used herein, is to be broadly interpreted to include any person, place, and/or thing capable of being captured as an image.

### Exemplary Device

In the following implementations, a smart camera may include a computer or components of a computer. Although many of today's smart phones provide for image capturing capabilities, the smart phones still lack the full functionalities of cameras. Cameras can capture high quality images via one or more lens assemblies that accurately reflect visual features of the subject. Furthermore, cameras are usually configurable. For some types of cameras, a user can change lenses, adjust aperture size, shutter speed, etc., to obtain digital images that smart phones cannot capture. With a smart camera, a user may capture high-quality images (some of which cannot be captured via smart phones), edit the images, and publish the images.

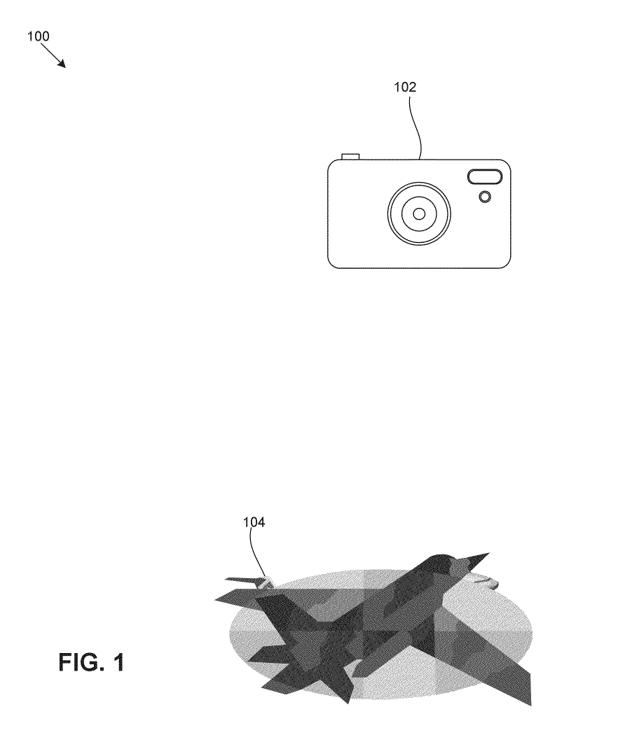

FIG. 1 shows an environment 100 in which concepts described herein may be implemented. As shown, environment 100 includes a smart camera 102 and a subject 104. In FIG. 1, subject 104 is depicted as an airplane, whose image cannot be captured by typical smart phone cameras when the plane is moving at a high speed. Given smart camera 102, a user may capture images of moving subject 104 by increasing the shutter speed and aperture size of smart camera 102. Once the user captures the desired images, the user may edit the images via applications stored on smart camera 102, and publish the images directly from smart camera 102 over a network.

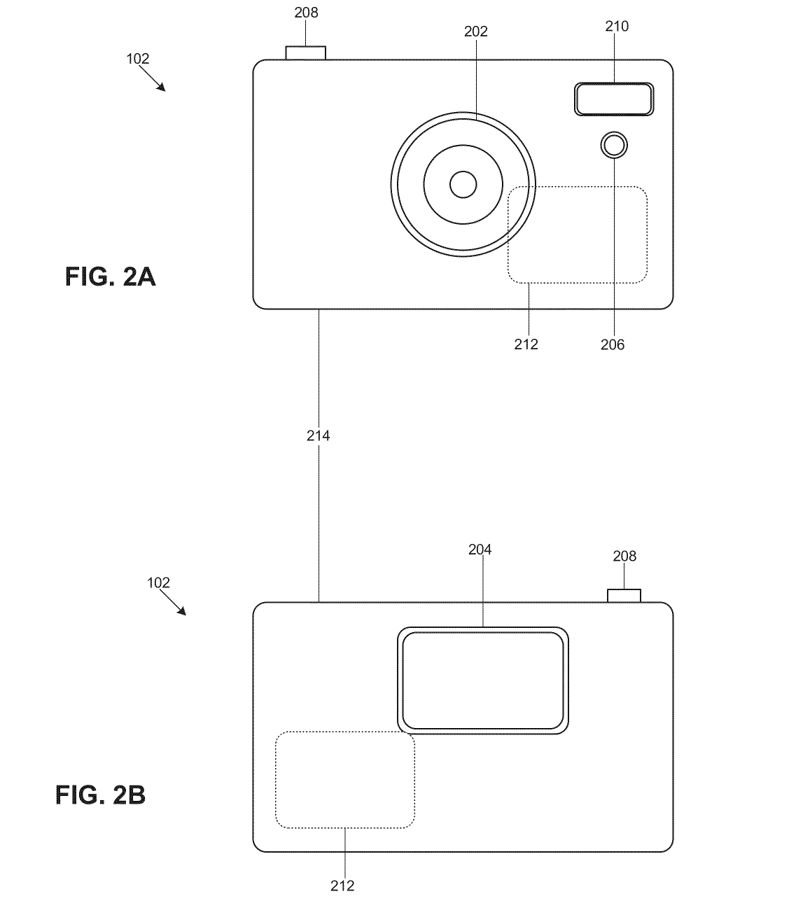

FIGS. 2A and 2B are front and rear views, respectively, of smart camera 102 according to one implementation. Smart camera 102 may include different types of cameras, such as a point-and-shoot camera, single-lens reflex (SLR) camera (e.g., a camera in which images that a user sees in the viewfinder are obtained from the same light rays received for capturing images).

As shown in FIGS. 2A and 2B, smart camera 102 may include a lens assembly 202, display/viewfinder 204, sensors 206, a button 208, a flash 210, a computing module 212, and a housing 214. Depending on the implementation, smart camera 102 may include additional, fewer, different, or a different arrangement of components than those illustrated in FIGS. 2A and 2B.

Lens assembly 202 may include a device for manipulating light rays from a given or a selected range, so that images in the range can be captured in a desired manner. Display/viewfinder 204 may include a device that can display signals generated by smart camera 102 as images on a screen and/or that can accept inputs in the form of taps or touches on the screen (e.g., a touch screen). The user may interact with applications (e.g., image processing application, email client, texting program, etc.) that run on computing module 212 via display/viewfinder 204. Sensors 206 may collect and provide, to smart camera 102, information (e.g., acoustic, infrared, etc.) that is used to aid the user in capturing images.

Button 208 may signal smart camera 102 to capture an image received by smart camera 102 via lens assembly 202 when the user presses button 208. Flash 210 may include any type of flash unit used in cameras and may provide illumination for taking pictures.

Computing module 212 may include one or more devices that provide computational capabilities of a computer. Computational module 212 may receive input/signals from different components of smart camera 102 (e.g., sensors 206, touch screen, etc.), process the input/signals, and/or control different components of smart camera 102. Computing module 212 may run applications, such as an image processing program, and interact with the user via input/output components. FIGS. 2A and 2B show computing module 212 in dotted lines, to indicate that computing module 212 is enclosed within housing 214.

Housing 214 may provide a casing for components of smart camera 102 and may protect the components from outside elements.

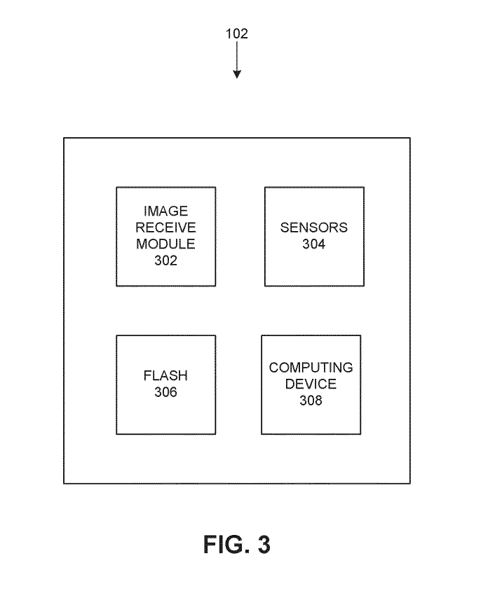

FIG. 3 is a block diagram of exemplary components of smart camera 102. As shown, smart camera 102 may include an image receive module 302, sensors 304, flash 306, and a computing device 308. Depending on the implementations, smart camera 102 may include additional, fewer, different, or a different arrangement of components than those illustrated in FIG. 3.

Image receive module 302 may include components that control receipt of light rays from a given or a selected range, so that images in the range can be captured in a desired manner. Image receive module 302 may be capable of manipulating images in ways that are not typically provided by smart phones (e.g., zoom>4×) or capture images at different shutter speed, etc.

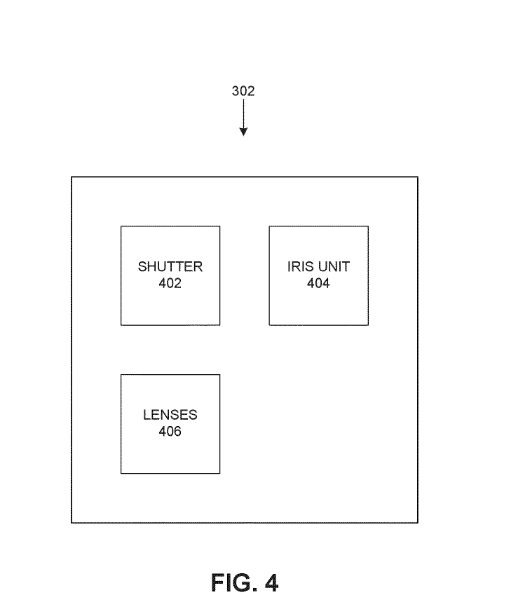

FIG. 4 is a block diagram of exemplary components of image receive module 302. As shown image receive module 302 may include shutter 402, iris unit 404, and lenses 406. Depending on the implementation, image receive module 302 may include additional, fewer, different, or a different arrangement of components than those illustrated in FIG. 4.

Shutter 402 may include a device for allowing light to pass for a period of time. Shutter 402 may expose sensors 304 (e.g., a charge coupled device (CCD)) to a determined amount of light to create an image of a view. Iris module 404 may include a device for providing an aperture for light and may control the brightness of light on sensors 304 by regulating the size of the aperture. Lenses 406 may include a collection of lenses, and may provide a magnification and a focus of a given or selected image, by changing relative positions of the lenses.

Shutter 402, iris module 404, and lenses 406 may operate in conjunction with each other to provide a desired magnification and an exposure. For example, when a magnification is increased by using lenses 406, a computational component (e.g., computing device 308) may adjust shutter 402 and iris unit 404 to compensate for changes in the amount of light, in order to maintain the exposure relatively constant.

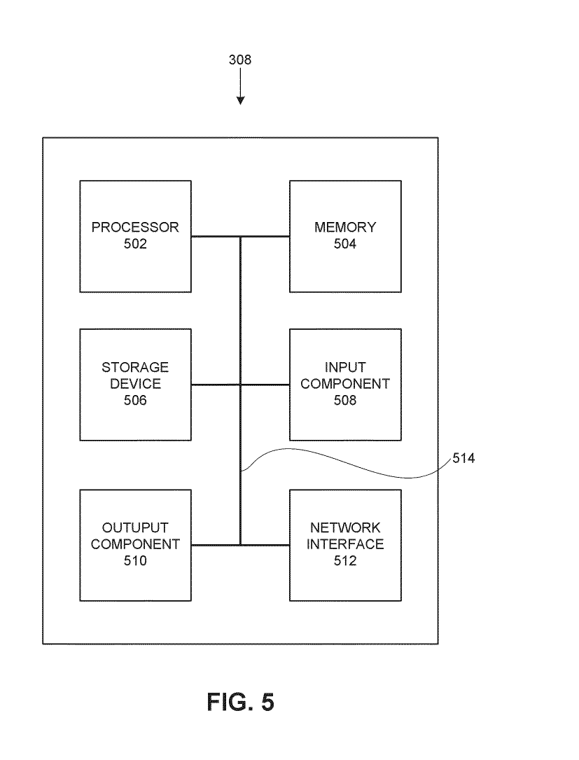

Returning to FIG. 3, sensor 304 may detect and receive information about the environment (e.g., distance of a subject from camera 102). Flash 306 may include flash 210, which is described above. Computing device 308 may include computing module 212, which is described above. FIG. 5 is a block diagram of exemplary components of computing device 308. As shown, computing device 308 may include a processor 502, memory 504, storage device 506, input component 508, output component 510, network interface 512, and communication path 514. In different implementations, computing device 308 may include additional, fewer, or different components than the ones illustrated in FIG. 5.

Processor 502 may include a processor, a microprocessor, an Application Specific Integrated Circuit (ASIC), a Field Programmable Gate Array (FPGA), and/or other processing logic capable of controlling computing device 308. In one implementation, processor 502 may include components that are specifically designed to control camera components. In other implementations, processor 502 may include a general processing unit (GPU). Memory 504 may include static memory, such as read only memory (ROM), and/or dynamic memory, such as random access memory (RAM), or onboard cache, for storing data and machine-readable instructions.

Storage device 506 may include a magnetic and/or optical storage/recording medium. In some embodiments, storage device 506 may be mounted under a directory tree or may be mapped to a drive. Depending on the context, the term “medium,” “memory,” “storage,” “storage device,” “storage medium,” and/or “storage unit” may be used interchangeably. For example, a “computer-readable storage device” or “computer readable storage medium” may refer to a memory and/or storage device.

Input component 508 may permit a user to input information to computing device 308. Input component 508 may include, for example, a microphone, a touch screen, voice recognition and/or biometric mechanisms, sensors, etc. Output component 510 may output information to the user. Output component 510 may include, for example, a display, a speaker, etc.

Network interface 512 may include a transceiver that enables computing device 308 to communicate with other devices and/or systems. For example, network interface 512 may include mechanisms for communicating via a network, such as the Internet, a terrestrial wireless network (e.g., a WLAN), a satellite-based network, a personal area network (PAN), a WPAN, etc. Additionally or alternatively, network interface 512 may include an Ethernet interface to a LAN, and/or an interface/connection for connecting computing device 308 to other devices (e.g., a Bluetooth interface).

Communication path 514 may provide an interface through which components of computing device 308 can communicate with one another.

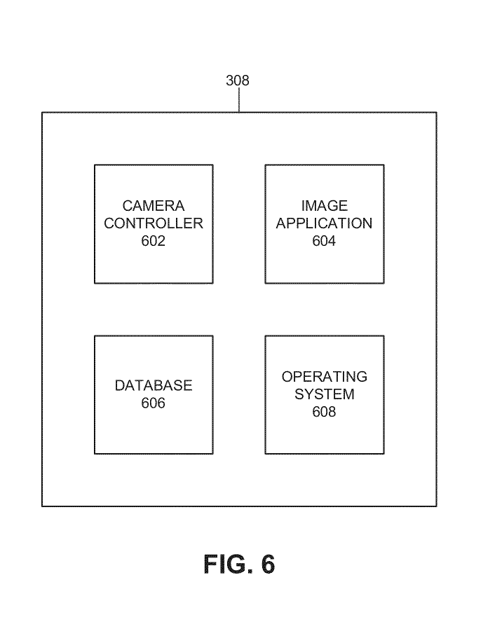

FIG. 6 is a block diagram of exemplary functional components of computing device 308. As shown, computing device 308 may include a camera controller 602, an image application 604, a database 606, and an operating system 608. The components illustrated in FIG. 6 may be executed by processor 302.

Camera controller 602 may control, for example, image receive module 302, flash 306, and/or another component of smart camera 102. As described above, in controlling image receive module 302, camera controller 602 may coordinate shutter 402, iris unit 404, and/or lenses 406 based on input from sensors 304 and user-provided parameters.

Image application 604 may include, for example, a photo/picture editing or manipulation program, a video/audio editing or manipulation program, etc. Database 606 may store images, videos, audio, and/or another type of information (e.g., messages, emails, etc.). Operating system 608 may allocate computational resources (e.g., processing cycles, memory, etc.) of computing device 308 to different components of computing device 308 (e.g., allocate memory/processing cycle to a process/thread).

Depending on the implementation, computing device 308 may include additional, fewer, different, or a different arrangement of components than those shown in FIG. 6. For example, in another implementation, computing device 308 may include software applications such as an email client, messaging program, browser, a document editing program, games, etc.

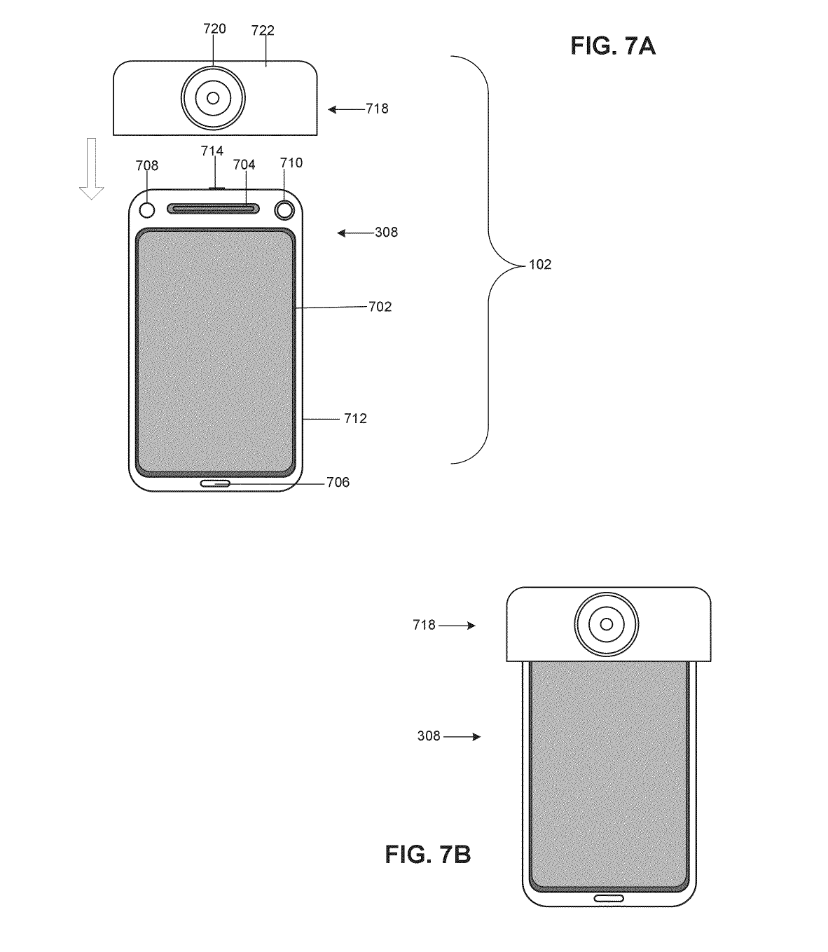

FIGS. 7A and 7B illustrate smart camera 102 according to another implementation. In this implementation, smart camera 102 may include computing device 308 and mountable camera assembly 718. Computing device 308 may include a cellular phone (e.g., a smart phone) and/or another type of communication device whose components include some or all of those illustrated in FIG. 5 and/or FIG. 6. As shown in FIG. 7A, computing device 308 may include a display 702, speaker 704, microphone 706, sensors 708, front camera 710, housing 712, and communication port 714. Depending on the implementation, computing device 308 may include additional, fewer, different, or different arrangement of components than those illustrated in FIG. 7A.

Display 702 may include similar device/components as display/viewfinder 204 and may operate similarly. Speaker 704 may provide audible information to a user of computing device 308. Microphone 706 may receive audible information from the user. Sensors 708 may collect and provide, to computing device 308, information (e.g., acoustic, infrared, etc.) that is used to aid the user in capturing images or in providing other types of information (e.g., a distance between a user and computing device 308). Front camera 710 may enable a user to view, capture and store images (e.g., pictures, video clips) of a subject in front of computing device 308. Housing 712 may provide a casing for components of computing device 308 and may protect the components from outside elements. Communication port 714 (e.g., universal serial bus (USB) port) may send or receive information from another device 308.

Mountable camera assembly 718 may include lens assembly 720 (which may be part of image receive module 302 included in mountable camera assembly 718) and housing 722. Lens assembly 720 may be configured to receive light rays and guide/direct the light rays inside housing 722 (e.g., via minors and beam splitters), such that when mountable camera assembly 718 is fitted with computing device 308 as illustrated in FIG. 7B, the light rays enter computing device 308 via front camera 710 or a rear camera (not shown) of computing device.

Mountable camera assembly 718 may include a connector or a port that fits together with or receives communication port 714 of computing device 308 when computing device 308 is inserted into mountable camera assembly 718. In this case, communication port 714 may function as both a communication port and a connection point. When computing device 308 is turned on, computing device 308 may control a number of components of mountable camera assembly 718 via communication port 714. In other implementations, mountable camera assembly 718 (e.g., zoom) may be controlled manually.

Lens assembly 720 may include lenses or other optical components that can manipulate light rays to produce far higher quality images than those produced via only front camera 710 or the rear camera of computing device 308. When computing device 308 is fitted with mountable camera assembly 718, computing device 308 may capture such high quality images. Furthermore, because lens assembly 720 is configurable (e.g., change aperture size, shutter speed, zoom, etc.), the user may capture far greater types of images by using the combination of mountable camera assembly 718 and computing device 308 than with just computing device 308. For example, lens assembly 720 may allow for zooms greater than 3× zoom (e.g., 4×, 5×, 6×, etc.).

Depending on the implementation, smart camera 102 may include computing device 308 and components that are different or differently configured than those illustrated in FIGS. 7A and 7B. For example, lens assembly 720 may be located on the rear of mountable camera assembly 718, to allow the user to view images, on display 702, that the user points to with lens assembly 720. In another example, mountable camera assembly 718 may be configured to receive a different portion of computing device 308 than the top portion of computing device 308, as illustrated in FIG. 7B. In some implementations, mountable camera assembly 718 may be assembled/coupled with computing device 308 via a different mounting mechanism (e.g., lockable clamp).

In yet another example, mountable camera assembly 718 may include a stand-alone camera, with a slot and a communication port for inserting/receiving a smart phone. In this instance, any images from the camera may be transferred to the phone via the communication port. Depending on the embodiment, a viewfinder on such camera may be kept large or small, depending on whether the camera has the capability for providing a user interface.

Depending on the implementation, computing device 308 may include large memories or one or more charge coupled devices (CCDs) of sufficient resolution to capture images that are provided via mountable camera assembly 718.

### Conclusion

The foregoing description of embodiments provides illustration, but is not intended to be exhaustive or to limit the embodiments to the precise form disclosed. Modifications and variations are possible in light of the above teachings or may be acquired from practice of the teachings.

It will be apparent that aspects described herein may be implemented in many different forms of software, firmware, and hardware in the implementations illustrated in the figures. The actual software code or specialized control hardware used to implement aspects should not be construed as limiting. Thus, the operation and behavior of the aspects were described without reference to the specific software code—it being understood that software and control hardware can be designed to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the invention have been described as “logic” that performs one or more functions. This logic may include hardware, such as a processor, an application specific integrated circuit, or a field programmable gate array, software, or a combination of hardware and software.

What is claimed is:

1. A device comprising:
an iris for adjusting an aperture for rays entering the device via the aperture, based on user input;
one or more lenses capable of zooming an image, formed by the rays, equal to or greater than a predetermined number of times the image;
a shutter whose speed is configurable based on user input; and
a computing device that includes:
a processor for controlling the device;
a memory for storing applications, data, and the image obtained via the iris, the one or more lenses, and the shutter;
a display for displaying the image; and
a communication interface for communicating with another device over a network.

2. The device of claim 1, wherein the predetermined number is 4.

3. The device of claim 1, wherein the computing device includes a cellular telephone.

4. The device of claim 1, wherein the processor is configured to at least one of:
modify the speed of the shutter based on a zoom of the one or more lenses;
change a size of the aperture by controlling the iris based on a zoom of the one or more; or
perform a zoom via the set of lenses based on user input.

5. The device of claim 1, further comprising a sensor, wherein the processor is further configured to:
automatically focus the image by controlling the one or more lenses prior to capturing the image.

6. The device of claim 1, wherein the computing device further comprises camera, and wherein the iris, the one or more lenses, and the shutters provide single-lens reflex images to the camera.

7. A system comprising:
a smart phone that includes a communication port and a camera; and
an image receiving module configured to physically couple to the smart phone via the communication port, comprising:
an iris for adjusting an aperture for rays entering the device via the aperture, based on user input;
one or more of lenses capable of zooming an image, formed by the rays, equal to or greater than a predetermined number of times the image; and
a shutter whose speed is configurable based on user input.

8. The system of claim 7, wherein the communication port is a universal serial bus (USB) port.

9. The system of claim 7, wherein the camera is located on a side, of the smart phone, that includes a display, or on another side, of the smart phone, that does not include the display.

10. The system of claim 7, wherein the predetermined number is 3.

11. The system of claim 7, wherein the smart phone is configured to:
send signals to control the set of lenses to autofocus the image.

12. The system of claim 7, wherein the image receiving module includes a single-reflex lens camera.
